(19) United States
(12) Patent Application Publication
(10) Pub. No.: US 2012/0226789 A1
(43) Pub. Date: Sep. 6, 2012

(54) Hiearchical Advertisement of Data Center Capabilities and Resources

(75) Inventors: Ashok Ganesan, San Jose, CA (US); Subrata Banerjee, Los Altos, CA (US); Ethan M. Spiegel, Mountain View, CA (US); Sumeet Singh, Saratoga, CA (US); Sukhdev S. Kapur, Saratoga, CA (US); Arpan K. Ghosh, Mountain View, CA (US)

(73) Assignee: CISCO TECHNOLOGY, INC., San Jose, CA (US)

(21) Appl. No.: 13/039,720

(22) Filed: Mar. 3, 2011

(51) Int. Cl. G06F 15/173

(52) U.S. Cl. 709/223

(57) ABSTRACT

A cloud computing system is provided comprising a plurality of data centers, each data center comprising a plurality of pods each of which comprises network, compute, storage and service node devices. At a designated device of a data center, data center level capabilities summary data is generated that summarizes the capabilities of the data center. Messages advertising the data center level capabilities summary data is sent from a designated device of each data center to a designated device at a provider edge network level of the computing system. At the designated device at the provider edge network level, provider edge network level capabilities summary data is generated that summarizes capabilities of compute, storage and network devices for each data center as a whole and without exposing individual compute, storage and service node devices in each data center.

### TECHNICAL FIELD

The present disclosure relates to advertising capabilities and resources in a cloud computing system.

### BACKGROUND

“Cloud computing” can be defined as Internet-based computing in which shared resources, software and information are provided to client or user computers or other devices on-demand from a pool of resources that are communicatively available via the Internet. Cloud computing is envisioned as a way to democratize access to resources and services, letting users efficiently purchase as many resources as they need and/or can afford.

In a cloud computing environment, numerous cloud service requests are serviced in relatively short periods of time. The cloud services consist of any combination of the following: compute services, network services, and storage services. Examples of network services include L2 (VLANs) or L3 (VRFs) connectivity between various physical and logical elements in the data center, L4-L7 services including firewalls and load balancers, QoS, ACLs, and accounting. In such an environment, it is highly beneficial to automate placement and instantiation of cloud services within and between data centers, so that cloud service requests can be accommodated dynamically with minimal (preferably no) human intervention.

### BRIEF DESCRIPTION OF THE DRAWINGS

FIG. 1 depicts a schematic diagram of a network topology that supports cloud computing and that operates in accordance with attribute summarization techniques.

FIG. 2 depicts a cloud resource device such as a web or application server, or storage device that includes Attribute Summarization Logic.

FIG. 3 depicts an aggregation node, such as an edge device, that includes Attribute Summarization Logic.

FIG. 4 depicts an example table that lists attributes and metadata that can be maintained by a cloud resource device consistent with the Attribute Summarization Logic.

FIG. 5 is an example publish message that can be sent from a cloud resource device to a next higher (aggregation) node in a network hierarchy.

FIGS. 6 and 7 are flow charts depicting example series of steps for operating a system in accordance with the Attribute Summarization Logic.

FIG. 8 is a diagram depicting a hierarchical advertisement scheme for data center capabilities and resources.

FIG. 9 is an example of a block diagram of an aggregation node configured to participate in the hierarchical advertisement scheme.

FIG. 10 is an example of a block diagram of a data center edge node configured to participate in the hierarchical advertisement scheme.

FIG. 11 is an example of a block diagram of provider edge node configured to participate in the hierarchical advertisement scheme.

FIG. 12 illustrates an example of a flow chart for the operations performed in a data center edge node in the hierarchical advertisement scheme.

FIG. 13 illustrates an example of a flow chart for the operations performed in a provider edge node in the hierarchical advertisement scheme.

### DESCRIPTION OF EXAMPLE EMBODIMENTS

### Overview

A cloud computing system is provided comprising a plurality of data centers, each data center comprising a plurality of pods each of which comprises compute, storage and service node devices. At a designated device of a data center, data center level capabilities summary data is generated that summarizes the capabilities of the data center. Messages advertising the data center level capabilities summary data is sent from a designated device of each data center to a designated device at a provider edge network level of the computing system. At the designated device at the provider edge network level, provider edge network level capabilities summary data is generated that summarizes capabilities of compute, storage and network devices for each data center as a whole and without exposing individual compute, storage and service node devices in each data center.

### Example Embodiments

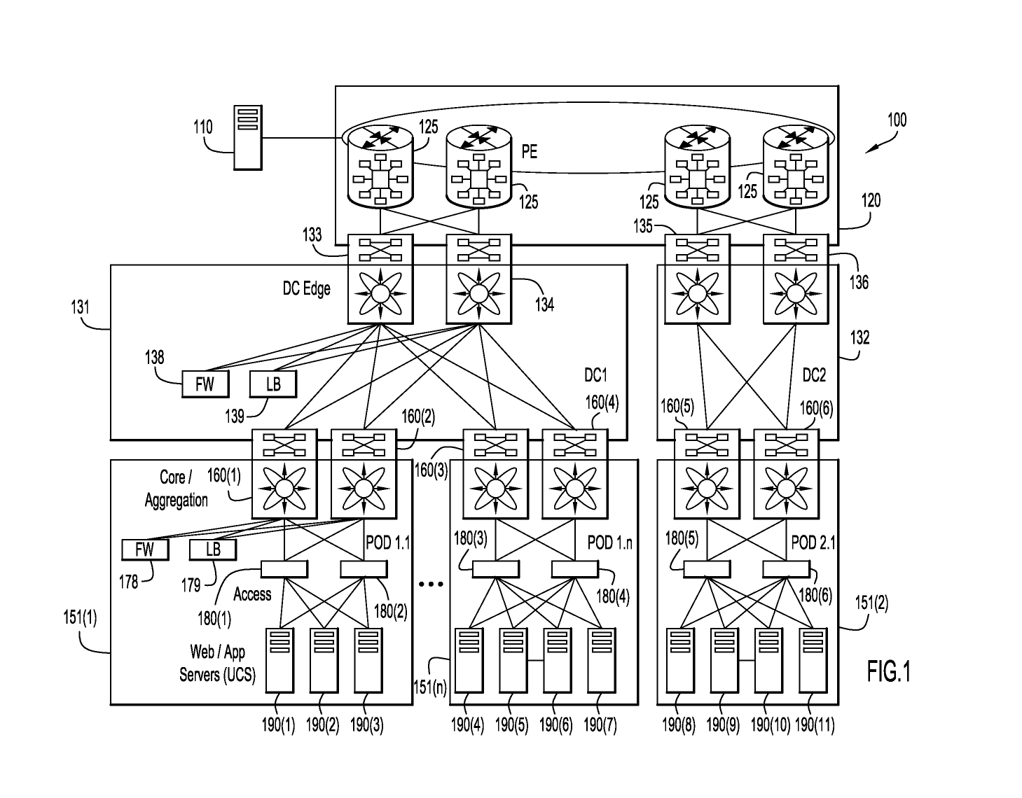

FIG. 1 depicts a schematic diagram of a network topology 100 that supports cloud computing and that operates in accordance with attribute summarization techniques. A top level network 120 interconnects a plurality of routers 125. Some of these routers 125 may be Provider Edge routers that enable connectivity to Data Centers 131, 132 via Data Center (DC) Edge routers 133, 134, 135, 136. Other routers 125 may be employed exclusively internally to top level network 120 as “core” routers, in that they may not have direct visibility to any DC Edge router.

Each Data Center 131, 132 (and using Data Center 131 as an example) may comprise DC Edge routers 133, 134 (as mentioned), a firewall 138, and a load balancer 139. These elements operate together to enable “pods” 151(1)-151(n), 152(1), etc., which respectively include multiple cloud resource devices 190(1)-190(3), 190(4)-190(7), 190(8)-190(11), to communicate effectively through the network topology 100 and provide computing and storage services to, e.g., clients 110, which may be other Data Centers or even stand alone computers. In a publish-subscriber system, which is one way to implement such a cloud computing environment, clients 110 are subscribers to requested resources and the cloud resource devices 190(1)-190(3), 190(4)-190(7), 190(8)-190(11) (which publish their services, capabilities, etc.) are the ultimate providers of those resources, although the clients themselves may have no knowledge of which specific cloud resource devices actually provide the desired service (e.g., compute, storage, etc.).

Still referring to FIG. 1, each pod, e.g., 151(1), may comprise one or more aggregation nodes 160(1), 160(2), etc. that are in communication with the multiple cloud resource devices 190 via access switches 180(1), 180(2), as may be appropriate. A firewall 178 and load balancer 179 may also be furnished for each pod 151 to ensure security and improve efficiency of connectivity with upper layers of network topology 100.

Further still, servers within a pod may be grouped together in what are called “clusters or cluster pools.” For example, if there are 100 physical servers in a pod, then they can be divided into four clusters each comprising 25 physical servers. Physical resources are shared within a cluster for load distribution, failure handling, etc. The notion of clusters may be viewed as a fourth hierarchical level (in addition to the pod level, data center level and provider edge level). The cluster level is subordinate to the pod level.

It is envisioned that there are some deployments that do not use all three (or even four) hierarchical levels (cluster, pod, data center and provider edge). For example, it is envisioned that the techniques described herein may be employed where there only two levels, e.g., data center level and provider edge level, where a data center is effectively viewed as one pod. In another example, the techniques described herein are employed for four levels: provider edge, data center, pod and cluster.

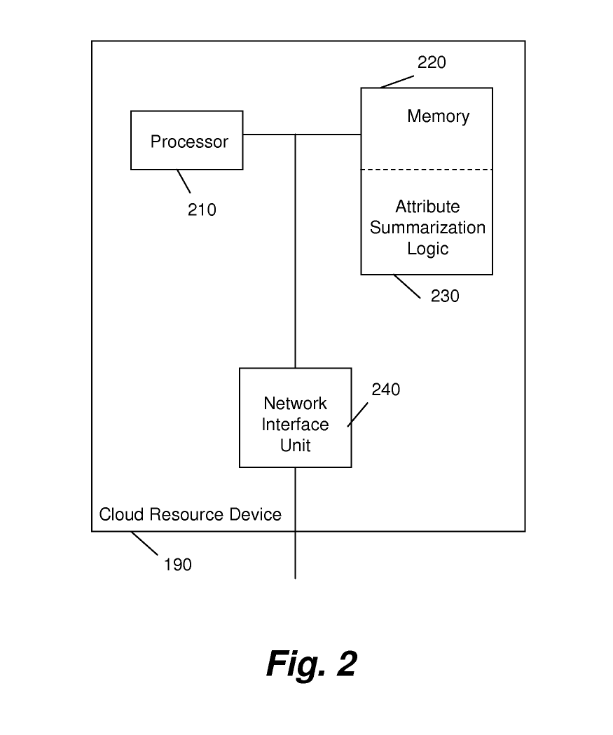

Cloud resource devices 190 themselves may be web or application servers, storage devices such as disk drives, or any other computing resource that might be of use or interest to an end user, such as client 110. FIG. 2 depicts an example cloud resource device 190 that comprises a processor 210, associated memory 220, which may include Attribute Summarization Logic 230 the function of which is described below, and a network interface unit 240 such as a network interface card, which enables the cloud resource device 190 to communicate externally with other devices. Although not shown, each cloud resource device 190 may also include input/output devices such as a keyboard, mouse and display to enable direct control of a given cloud resource device 190. Those skilled in the art will appreciate that cloud resource devices 190 may be rack mounted devices, such as blades, that may not have dedicated respective input/output devices. Instead, such rack mounted devices might be accessible via a centralized console, or some other arrangement by which individual ones of the cloud resource devices can be accessed, controlled and configured by, e.g., an administrator.

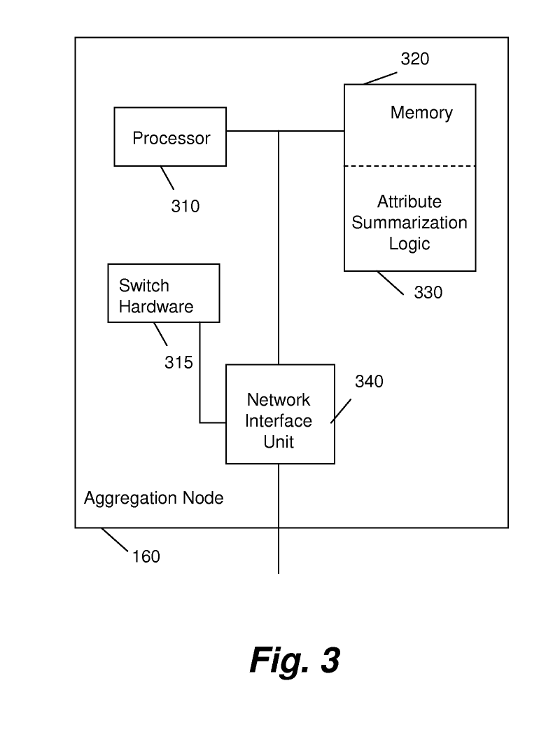

FIG. 3 depicts an example aggregation node 160, which, like a cloud resource device 190, may comprise a processor 310, associated memory 320, which may include Attribute Summarization Logic 330, and a network interface unit 340, such as a network interface card. Switch hardware 315 may also be included. Switch hardware 315 comprises one or application specific integrated circuits and supporting circuitry to buffer/queue incoming packets and route the packets over a particular port to a destination device. The switch hardware 315 may include its own processor that is configured to apply class of service, quality of service and other policies to the routing of packets.” Aggregation node 160 may also be accessible via input/output functionality including functions supported by, e.g., a keyboard, mouse and display to enable direct control of a given aggregation node 160.

Processors 210/310 may be programmable processors (microprocessors or microcontrollers) or fixed-logic processors. In the case of a programmable processor, any associated memory (e.g., 220, 320) may be of any type of tangible processor readable memory (e.g., random access, read-only, etc.) that is encoded with or stores instructions that can implement the Attribute Summarization Logic 230, 330. Alternatively, processors 210, 310 may be comprised of a fixed-logic processing device, such as an application specific integrated circuit (ASIC) or digital signal processor that is configured with firmware comprised of instructions or logic that cause the processor to perform the functions described herein. Thus, Attribute Summarization Logic 230, 330 may be encoded in one or more tangible media for execution, such as with fixed logic or programmable logic (e.g., software/computer instructions executed by a processor) and any processor may be a programmable processor, programmable digital logic (e.g., field programmable gate array) or an ASIC that comprises fixed digital logic, or a combination thereof. In general, any process logic may be embodied in a processor or computer readable medium that is encoded with instructions for execution by a processor that, when executed by the processor, are operable to cause the processor to perform the functions described herein.

As noted, there can be many different types of cloud resource devices 190 in a given network including, but not limited to, compute devices, network devices, storage devices, service devices, etc. Each of these devices can have a different set of capabilities or attributes and these capabilities or attributes may change over time. For example, a larger capacity disk drive might be installed in a given storage device, or an upgraded set of parallel processors may be installed in a given compute device. Furthermore, how a cloud, particularly one that operates consistent with a publish-subscribe model, might view or present/advertise these capabilities or attributes in aggregate to potential subscribers may vary from one capability or attribute type to another.

More specifically, in one possible implementation of a cloud computing infrastructure like that shown in FIG. 1, including the devices shown in FIGS. 2 and 3, it may be desirable to advertise or publish the capabilities or attributes of each of the cloud resource devices 190 (or some aggregated version of those capabilities or attributes) throughout the cloud or network. That is, to effect efficient cloud computing, a network wide hierarchical property and capability map of all network attached entities (e.g., cloud resource devices 190) could be automatically generated by having the devices independently publish (advertise) their capabilities via the publish-subscribe mechanism. However, relaying all such information as it is published by each of the cloud resource devices 190 to all potential subscribers (higher level nodes, and clients, in the network hierarchy), might easily result in an overload of messages, and unnecessarily bog down the receivers/subscribers. For this reason, the publish-subscribe mechanism, consistent with the Attribute Summarization Logic 230/330, is configured to summarize device attributes within respective domains, and then publish resulting summarizations to a next higher level domain in the overall network topology 100.

In one embodiment, the capabilities or attributes published by devices (e.g., cloud resource devices 190) in a domain at the lowest layer of the network hierarchy (e.g., within pod 151) are summarized/aggregated into a common set of capabilities associated with the entire domain. Thus, referring again to FIG. 1, the capabilities of individual cloud resource devices 190 within, e.g., Data Center pod 151(1) are associated with the entire Data Center pod as a whole, without any notion of the different cloud resource devices 190 within Pod 151 or the connectivity between such devices 190 via, e.g., access switches 180. As will be explained more fully below, aggregation and summarization of capabilities and attributes continues from each layer of the hierarchy to the next, enabling clients/subscribers to obtain the services they desire without bogging down the overall network.

In an embodiment, each device can advertise (publish) its capabilities or attributes on a common control plane. Such a control plane could be implemented using a presence protocol such as XMPP (eXtensible Markup Presence Protocol), among other possible protocols or mechanisms that enable devices to communicate with each other.

Significantly, and in an effort to maintain a certain level of automation in the attribute summarization process, not only is a given attribute published or advertised, but an extensible aggregation function is provided along with that given attribute that enables the device that is publishing the attributes to specify the manner in which the attribute should be treated/aggregated or summarized at a next higher level in the network hierarchy. Extensibility in this context is desirable as different attributes may need to be summarized differently. For example, depending on the type of attribute, the attribute may be summarized with other like attributes of other devices via primitives such as concatenation, addition, selection of a lesser of values, etc. In one implementation, the Attribute Summarization Logic 230/330 may provide and/or support a comprehensive list of primitive aggregation functions (e.g., SUM, MULTIPLY, DIFFERENCE, AVERAGE, STANDARD DEVIATION, CONCATENATION, LENGTH, LESSER_OF, GREATER_OF, MAX, MIN, UNION, INTERSECTION, etc.), and the devices can then specify which one of (or combination of) the primitive functions to use when the attributes of a given device are to be summarized. The selection of a primitive aggregation function could be performed automatically, or may be performed manually by an administrator.

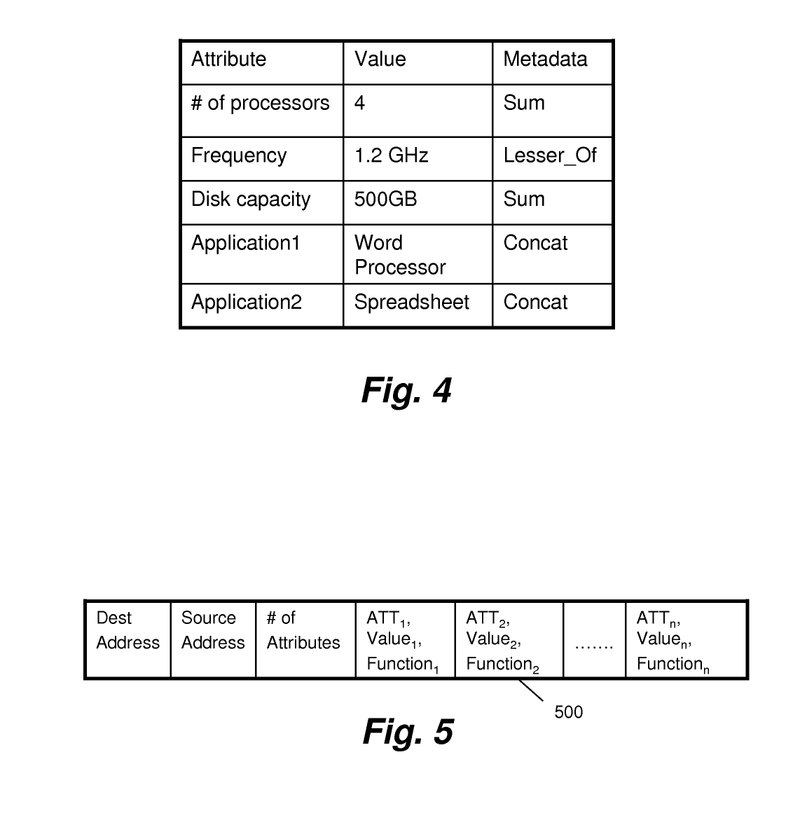

FIG. 4 depicts a table that lists example attributes and metadata related to the attributes that can be maintained by, e.g., cloud resource device 190 consistent with the Attribute Summarization Logic 230/330. Specifically, assume the cloud resource device 190 is a general purpose server device that includes multiple processors (cores), has a certain disk drive capacity, and hosts multiple applications (App₁, App₂). As shown in the table of FIG. 4, each of the foregoing attributes is associated with metadata (e.g., a function) that describes how each attribute should be summarized with other like attributes of other, e.g., cloud resource devices 190. Specifically, the attribute “# of processors” is associated with the primitive “SUM” as its metadata. This means that when this particular attribute is published to a next higher level node in the network topology 100, e.g., aggregation server 160, that node will take the number of processors (4 in this case, as shown in the value column of the table) and add it to any currently running tally of number of processors. Thus, assume, for example, that a given client 110 seeks the processing power of eight processors, and an aggregation server 160 might have added together the number of processors from each of multiple cloud resource devices 190 resulting in a total of 20 such processors. Accordingly, from the perspective the client 110, the Aggregation server 160 can provide the power of eight processors.

Still with reference to FIG. 4, the attribute of disk capacity might also be associated with the metadata “SUM” as an instruction on how to summarize this attribute with similar attributes. For the applications (App₁, App₂) that might be hosted on the general purpose server, those applications might be associated with a concatenation instruction or function such that a list of applications might result upon summarization. For instance, a resulting summarization might be: “word processor, spreadsheet, relational database” or some numerical value of those applications. A next higher node in the network topology would receive this summarized list and be able match the list of portions thereof to subscribe messages generated by clients 110.

FIG. 5 is an example publish message 500 that can be sent from a cloud resource device 190 to a next higher node, e.g., aggregation server 160, in a network element hierarchy. In an embodiment, the Attribute Summarization Logic 230 generates the message 500 from data like that shown in the table of FIG. 4. The message 500 may include a destination address (a next higher node), a source address (that identifies, e.g., the cloud resource device 190) and one or more attributes that characterize the cloud resource device 190. As shown, each attribute (Att₁, Att₂, . . . Attₙ) has associated metadata including a value along with an instruction, directive or function that provides a rule by which the associated attribute should be summarized with other like attributes of other cloud resource devices. Thus, each publish message 500 might be thought of as a set of information (e.g., a tuple) of any predetermined length that includes an attribute and metadata that describes a value of the attribute and a function, instruction, directive, etc. regarding how to combine the associated attribute (or value thereof) with other like attributes.

In light of the foregoing, those skilled in the art will appreciate that the Attribute Summarization Logic 230 enables each device to independently determine the attributes that it would like to advertise or publish. The Attribute Summarization Logic 230 also enables the device to provide metadata about those attributes. This approach allows for attributes, which are not a priori known or understood by a next higher node carrying out the summarization function, to still be intelligently summarized/aggregated and then published at a still next layer up in the hierarchy. In one possible implementation, cloud resource devices 190 could provide customers with the ability to configure their own attributes that are not understood by the devices themselves, but are intelligently summarized/aggregated and published up the hierarchy, then referenced in customer policies for hierarchical rendering and provisioning of services.

The following is another example of how the Attribute Summarization Logic 230 may operate. Consider an example of advertising “compute” power through the network hierarchy. Each cloud resource device can advertise the number of cores it has available along with the operating frequency of each core. For example, Device A advertises 4C@ 1.2 Ghz, Device B advertises 4C@ 1.2 Ghz, and Device C advertises 4C@2.0 Ghz. Each of these cloud resource devices will publish this information to a first logical hop, e.g., aggregation node 160. At that node Attribute Summarization Logic 330 might aggregate or summarize the received information into one advertisement of “8C@ 1.2 Ghz, 4C@2.0 Ghz.” In contrast, a traditional publish-subscribe system might have simply sent or forwarded the three originally received individual advertisements. Note that, in this case, the summarization is not a simple summing operation, but is instead a function. Such a function can make use of one or more operations, including but not limited to SUM, MULTIPLY, DIFFERENCE, AVERAGE, STANDARD DEVIATION, CONCATENATION, LENGTH, LESSER_OF, GREATER_OF, MAX, MIN, UNION, INTERSECTION, among others.

In this particular example, the function underlying summarization is: compare the frequency, and if they are equal then add the number of cores.

More specifically, consider that the elements are arranged in a <key,value> array, where key is the operating frequency and the value is the number of cores. That is, and referring again to FIG. 4, more than one attribute is considered simultaneously for this particular function, where the function might be defined as:

aggregation_function(input[ ])
{

for each element e in input,

If input speed of e= x Ghz
{

output[x] += number of cores in the input;

}

return output;

}

That is, for each core having a given operating frequency, add that core to a running total. In this way, a next higher node in the network hierarchy can efficiently summarize attributes, or even combinations of attributes of nodes from a next lower level in the network hierarchy.

Those skilled in the art will appreciate that more complex operations might be implemented. For instance, it might be desirable to consider multiple dimensions including, e.g., memory, storage, processor type (PPC, X86, ARM, 32 bit, 64 bit etc.), connectivity, bandwidth, etc. All such attributes can be summarized consistent with instructions or functions delivered in the metadata (which might even include an explicit equation) that is provided along with the attributes in a message like that shown in FIG. 5.

Another example of a summarization function is “intersection,” as noted above. For example, it may be desirable to determine the intersection of routing protocols supported in a routing domain across different routers. Consider the following:

Router 1 supports: BGP (Border Gateway Protocol), OSPF (Open Shortest Path First), RIP (Routing Information Protocol), ISIS (Intermediate System to Intermediate System); summarization operator (function)=intersection.

Router 2 supports: BGP, RIP, ISIS; summarization operator (function)=intersection.

Summarized information according to intersection would be: BGP, RIP, ISIS.

Intersection may be a useful function in that all routers in a given routing domain should communicate via the same protocol.

It is apparent that any attempt to aggregate multiple resources from within a given domain into one set of resource values to be advertised to the next higher domain can result in loss of information. There is an inherent tradeoff whenever summarization is introduced: scale is improved, but accuracy is decreased due to loss of detailed information. “Resource groups” are one tool that can help improve the accuracy in representing resources to higher layers in the hierarchy, at the expense of increased amounts of information.

For example, it is not possible to accurately aggregate the following capabilities into only one processing capacity value and one value for available bandwidth:
2 GHz processing capacity is reachable through links with 2 Gbps available bandwidth; and
10 GHz processing capacity is reachable through links with 500 Mbps available bandwidth.

A conservative approach would advertise 2 GHz processing capacity with 500 Mbps available bandwidth. Requests to a Data Center control point for more than 2 GHz processing capacity that only require 500 Mbps available bandwidth would not be directed, however, to a pod having the above published summarization.

On the other hand, an aggressive approach might result in advertising 10 GHz processing capacity with 2 Gbps available bandwidth. Requests for more than 2 GHz processing capacity along with more than 500 Mbps available bandwidth may still be directed towards the pod, even though such a combination cannot be supported. The pod control point would have to reject this request, leaving the Data Center control point to select a different pod.

In order to advertise such combinations more accurately, the notion of a resource group can be introduced. The combination of capabilities above can be accurately represented by advertising two resource groups for the same network element. One resource group can reflect the combination of 2 GHz processing capacity and 2 Gbps available bandwidth. The other resource group can reflect the combination of 10 GHz processing capacity and 500 Mbps available bandwidth.

Thus, a resource group can be considered a collection of disparate resources collected together into one container for the purposes of accounting and consumption. A particular resource may be merged into one or more resource groups and the composition (which resource types/attributes are aggregated) of a given resource group may change at run-time. New resource groups can be created while the system is in operation.

The publishers of the information may not be aware of resource groups at all or of which resource group they will be a part, as any association into resource groups is performed as the resource advertisements are received and analyzed at next higher levels within the network hierarchy or, more generally, at different nodes not necessarily arranged in a hierarchy.

As an example, suppose the following Resource Group Templates are defined by an administrator:

“Memory Intensive Apps”: this group may comprise cores that have access to 4 GB of RAM;

“Compute intensive apps”: this group may comprise cores that operate at a minimum of 2 Ghz; and

“Bandwidth intensive apps”: this group may comprise cores that may be connected using 10 Gbps links.

Now consider cloud resource devices with the following published advertisements:

“2cores@2 Ghz@4 GBRAM” connected to a switch using a 1 Gbps link; and

“4cores@1 Ghz@16 GBRAM” connected to the switch using a 10 Gbps link.

When the advertisements arrive at a next higher level node the node can export three resource groups, namely:

a “Memory Intensive” resource group with the advertisement “5 units” (20 GBRAM/4);

a “Compute Intensive” resource group with the advertisement “2 units” (only 2 cores total operate at least 2 GHz; and

a “Bandwidth Intensive” resource group with the advertisement “4 units” (only 4 of the cores are connected via a 10 Gbs link).

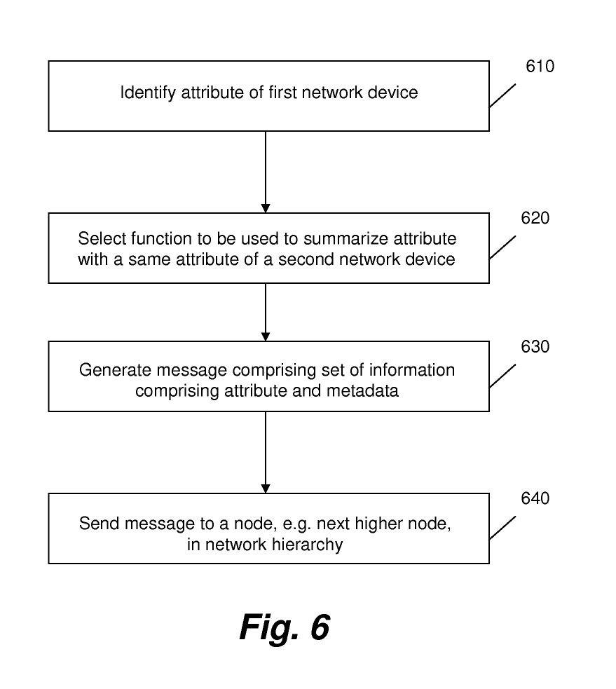

FIG. 6 is a flow chart depicting an example series of steps for operating a system in accordance with the Attribute Summarization Logic 230. At step 610, at first a network device, an attribute of the first network device is identified. The attribute, such as number of cores/processors, clock frequency, amount of memory etc., may be identified automatically or manually by an administrator.

Then, at step, 620, a function that defines how the attribute is to be summarized together with a same attribute of a second network device is selected. The function could, for example, be any one of count, sum, multiply, divide, difference, average, standard deviation or concatenate and even include a more elaborate equation or program. At step 630, a message is generated that comprises a set of information (e.g., a tuple) comprising an identification of the attribute and the function, and then at step 640, the message is sent to a next higher node in a network hierarchy of which the network device is a part. In an embodiment, the message is sent using a presence protocol such as XMPP. Although not required, the first and the second network device may be at a same level within the network hierarchy such that a next higher node in the network hierarchy can receive a plurality of such messages and summarize the attributes of lower level entities. The messages may also be publish or advertisement messages within a publish-subscribe system.

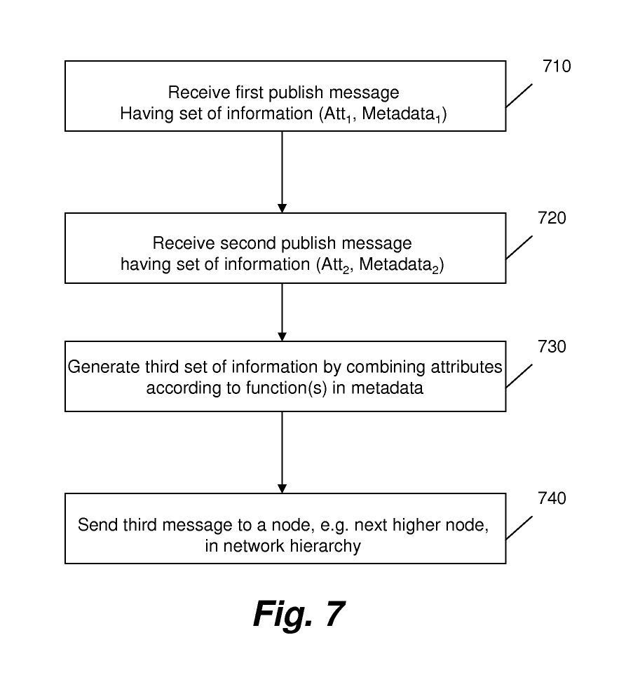

FIG. 7 is a flow chart depicting an example of another series of steps for operating a system in accordance with the Attribute Summarization Logic.

As shown, at step 710, at, e.g., an aggregation node of a data center comprising a plurality of network devices, a first publish message from a first network device is received, and the first publish message from the first network device includes a first set of information (e.g., a tuple) having a form (attribute₁, metadata₁), wherein a given attribute describes a capability of the first network device. At step 720, at, e.g., the same aggregation node of the data center, a second publish message from a second network device is received, and the second publish message from the second server includes a second set of information (e.g., a tuple) having the form (attribute₂, metadata₂). At step 730, a third set of information (e.g., a tuple) is generated by combining information in the first set and the second set consistent with functions defined by the metadata, and at step 740, a third publish message is sent to a next higher aggregation node in a hierarchical structure of which the aggregation node is a member, the third publish message comprising the third set.

As explained, the summarizing node can also generate resource groups that combine and summarize attributes from multiple network devices in different ways. Thus, the first publish message and the second publish message may each comprise a plurality of attributes and respective metadata, and the overall methodology may further generate a plurality of groupings (resource groups) that summarize and combine the attributes in different ways to satisfy, perhaps, predetermined templates.

In order to make intelligent placement decisions in a cloud computing system, it is highly beneficial to expose the capabilities and resources of all cloud elements (compute, network, and storage) to the resource managers that make the cloud services placement decisions. The goal is to minimize instantiation failures and retries due to insufficient resources or capabilities at individual cloud elements, while accommodating all cloud service requests for which sufficient available resources and capabilities exist.

Advertisement of capabilities and resources of all cloud elements should be done in a manner that exposes sufficient detail for resource managers to accurately place cloud services. However, these advertisements should be constrained so that the solution scales to numerous very large data centers with hundreds of thousands of servers, without overwhelming the Cloud Control Plane that receives and processes the advertisements.

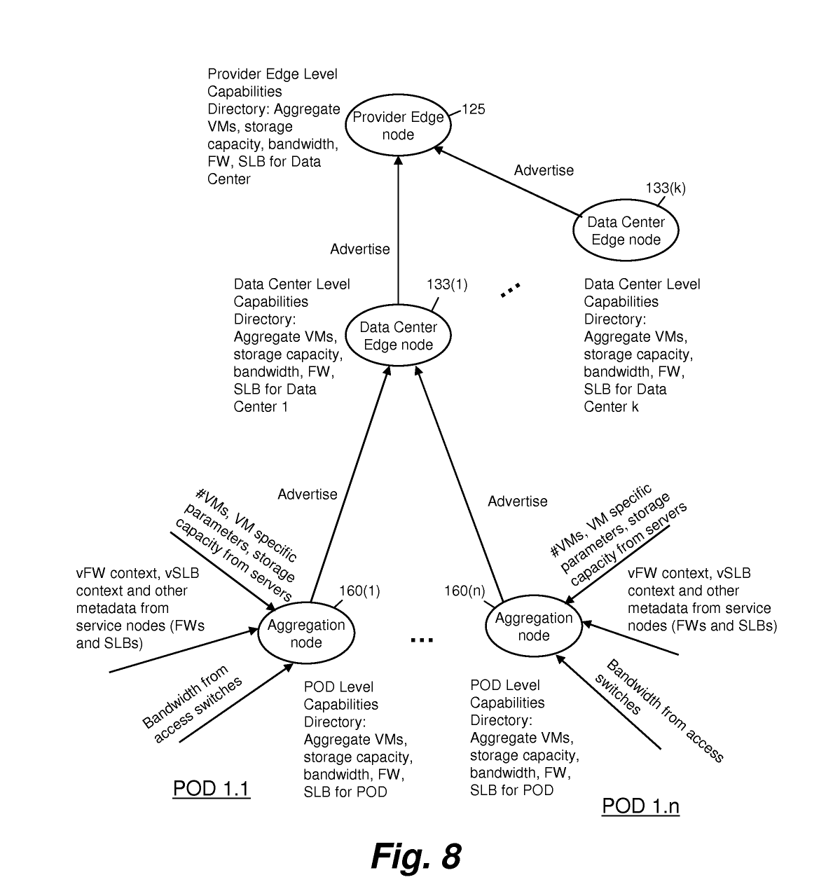

Turning to FIG. 8 also with reference to FIG. 1, a hierarchical mechanism is now described for advertisement of resources and capabilities within and between data centers in a cloud computing system. This mechanism allows the Cloud-Centric Networking (CCN) Control Plane to leverage capabilities and resources that are distributed amongst different cloud elements by creating a unified view of these resources and presenting them as a unified pool of resources that can be deployed in a flexible way, thereby hiding the device level details and complexities from the provisioning layer.

The resources and capabilities that are advertised span compute, network (service node), and storage devices, including dynamic capacities that fluctuate as cloud service requests come and go and also fluctuate due to varying traffic loads. A resource and capability database is maintained in a distributed and node fault-tolerant manner.

Capabilities advertisement is carried out by constructing a hierarchical tree of advertisement domains, also called advertisement levels or layers, as shown in FIG. 1 and depicted by the flow of information data in FIG. 8. Within each domain, there are one or more servers that collect advertisements, for example using a publish/subscribe mechanism such as that offered by XMPP. All nodes in the domain publish their capabilities to the servers for that advertisement domain. The information collected at the servers is then summarized for the next level up in the hierarchy, advertising an aggregate node representing the entire child domain, to the servers for the parent domain.

The lowest level of the hierarchy is typically the POD, e.g., PODs 151(1)-151(n) and 152(1) shown in FIG. 1, which extends from aggregation switches down through access switches to compute and storage devices. Within a POD, compute servers, L4-L7 service nodes (e.g., access switches, FW and LB devices), storage nodes (storage arrays) advertise their capabilities, using the techniques described above in connection with FIGS. 4-7, for example. The storage nodes are assumed to be part of or associated with the compute devices, e.g., web/application servers 190 shown in FIG. 1. The servers for the POD advertisement domain are deployed on a designated device of each POD, such as on an aggregation switch as shown in FIG. 1 or in virtual machines that runs on a compute device in that POD or in some other POD, or in a compute device at some other location not associated with any POD. The resulting POD level Capabilities Directory contains a network view for that POD. Moreover, since this is the lowest level of the hierarchy, this view contains the full topology of the POD including all nodes and interfaces along with their individual capabilities and resources.

Thus, for POD 1.1 shown in FIG. 8, at a designated device, e.g., at aggregation node 160(1), advertisement messages are received from the one or more compute, storage an service node devices, the advertisement messages advertising the capabilities of these respective cloud elements. These messages may be generated and formatted as described above in connection with FIGS. 4-7. For example, the messages advertising the compute and storage capabilities associated with web and application servers may indicate the number of virtual machines (VMs), VM specific parameters such as CPU, memory, virtual network interface cards, and storage capacity. The messages advertising the capabilities associated with service nodes (e.g., FWs and LBs) may comprise virtual FW (vFW) context, virtual LB (vSLB) context and other metadata. A vFW or vLB context is an independent and logical management and forwarding domain within a physical entity. In addition, access switches send advertisement messages indicating their bandwidth, support for various forwarding protocols, interface capabilities. This type of advertising is performed for all PODs, and thus aggregation node 160(n) receives advertisement messages from its constituent compute, storage and service node devices.

The aggregation nodes 160(1)-160(n) running the servers for the POD advertisement domain or level, generate the POD level Capabilities Directory data that summarizes the POD level inventory and propagates that data to a designated device at the next level up in the advertisement hierarchy, which is typically the Data Center level. In other words, the aggregation nodes 160(1)-160(n) send messages advertising their POD level capabilities summary data to a designated device of their corresponding data center, e.g., to Data Center edge node 133(1), e.g., an edge switch, in the example shown in FIG. 8. A similar flow of advertisement messages occurs for each of a plurality of data centers to a corresponding edge node as indicated by Data Center edge node 133(k) shown in FIG. 8.

Each Data Center edge node receives the messages advertising the POD level capabilities summary data from the aggregation nodes of each constituent POD and generates a Data Center Level Capabilities Directory. The Data Center Level Capabilities Directory comprises data center level capabilities summary data that summarizes the capabilities for all PODs for that data center without exposing individual compute, storage and service node devices in each POD and well as individual resources at the data center level, i.e., those that are not included in any of the PODs. For example, Data Center edge node 133(1) generates a Data Center Level Capabilities Directory that indicates the aggregate VMs, storage capacity, bandwidth, FW, SLB for Data Center 1 and Data Center edge node 133(k) generates a Data Center Level Capabilities Directory that indicates the aggregate VMs, storage capacity, bandwidth, FW, SLB for Data Center k.

The resulting Data Center Level Capabilities Directory describes the aggregate POD capabilities such as compute, L4-L7 services, and storage advertised for a POD to the data center level are associated with the POD as a whole. Individual servers, appliances, and switches within the POD are not exposed at the data center level. Not “exposing” individual devices at the data center level means that the Data Center Level Capabilities Directory data does not specifically identify or refer to a particular device, e.g., server 190(1) in POD 151(1), that has a certain compute capacity (e.g., VM capacity). Rather, the capacity of any given component, e.g., server 190(1), is reflected in the summary data. Thus, the data center level capabilities summary data does not specifically refer to or identify any particular compute, storage or service node device in any of the PODs. Examples of data center level capabilities are data center edge switches, perimeter firewalls, inter-POD load balancers, intrusion detection systems, wide area network (WAN) acceleration services, etc. Furthermore, switches and other appliances that reside outside of the PODs are advertised individually at the data center level, including interfaces, so that the data center level topology can be derived.

The nodes running the servers for the data center advertisement domain summarize the data center level inventory and propagate that to the servers for the provider edge network level, also referred to herein as the Next Generation Network (NGN) advertisement domain. The NGN level is also referred to as the provider edge (PE) level. That is, the Data Center edge nodes 133(1)-133(k) send messages advertising their capabilities summary data to a designated device at the provider edge network or NGN level. Like that for the POD level, the aggregate data center capabilities such as compute, L4-L7 services, and storage capabilities are advertised as being associated with a given data center as a whole. Individual servers, appliances, and switches within the data center are not exposed at the provider edge network or NGN level, similar to that described above for the data center level. Switches that reside outside of the data centers are advertised individually at the data center level, including interfaces so that the NGN level topology can be derived. Thus, at a designated device at the provider edge network level, e.g., provider edge node 125, provider edge network level capabilities summary data is generated that summarizes the capabilities of compute, storage and network devices within each data center as a whole without exposing individual compute, storage and service node devices in each data center. Thus, like the data center level capabilities summary data, the provider edge network level capabilities summary data summarizes the capabilities for all PODs within a given data center and without specifically referring to or identifying any particular compute, storage or service node device in any of the PODs of any of the data centers. Examples of provider edge network level capabilities summary data are types and numbers of virtual private networks (VPNs) supported, proximity information (network distance between customer data center and service provider data center), performance of the connection between two data centers such as delay, jitter, packet loss etc., number of virtual routers/forwarders supported by the PE routers.

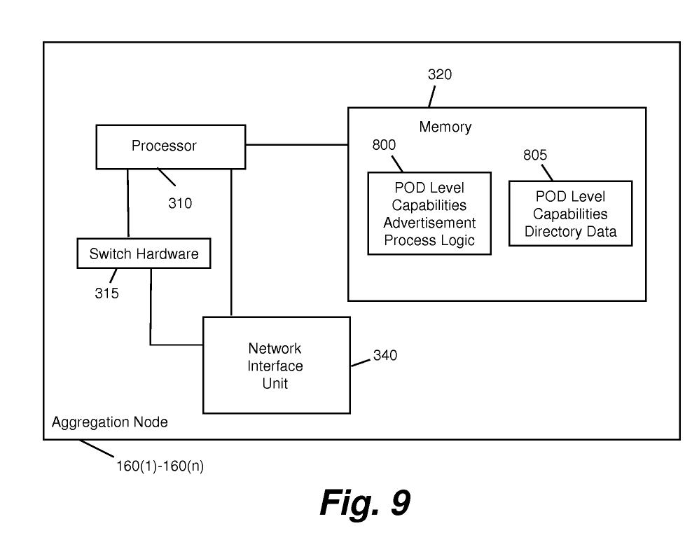

Reference is now made to FIG. 9 for a description of an aggregation node configured to participate in the hierarchical advertising capabilities process described above in connection with FIG. 8. FIG. 9 is similar to FIG. 3. The aggregation node comprises a processor 310, switch hardware 315, memory 320 and network interface unit 340. The memory 310 stores executable instructions for POD Level Capabilities Advertisement Process Logic 800 and also stores POD Level Capabilities Directory data 805. The POD Level Capabilities Advertisement Process Logic 800 causes the processor 310 to receive messages advertising capabilities from compute, storage and service node devices in the POD in which the aggregation node is deployed and to generate therefrom the POD Level Capabilities Directory 805 comprising capabilities summary data for the POD. The POD Level Advertisement Process Logic 800 also causes the processor 310 to generate and send a message advertising the POD level capabilities summary data to the edge node for the corresponding data center.

When the servers within a data center are grouped into clusters such that each pod comprises a plurality of clusters of compute devices, then the designated device, e.g., the logic 800 of the aggregation node is further configured to receive advertising messages that advertises capabilities of each cluster of computer devices in the corresponding pod and to generate the pod level capabilities summary data to include data representing the capabilities of each cluster of computer devices in the corresponding pod. When server clusters are employed, the pod level capabilities summary data may include cluster capabilities data without exposing (that is, without specifically referring to or identifying) individual compute devices.

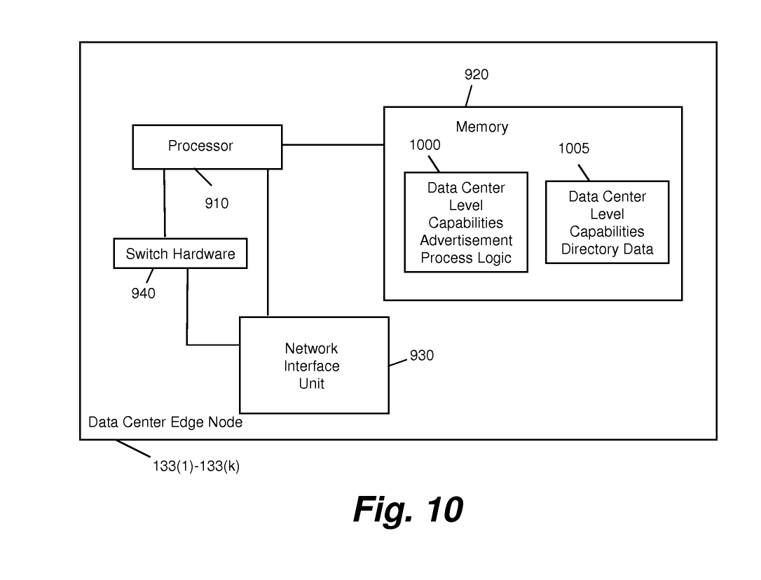

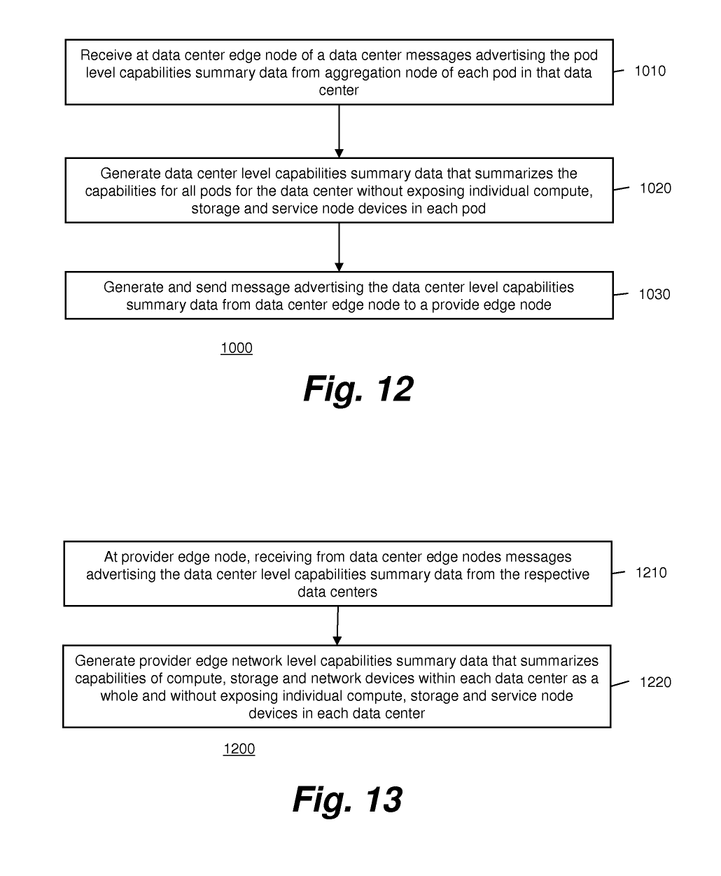

Turning now to FIG. 10, an example of a block diagram of a data center edge node is shown, e.g., any of the edge nodes 133(1)-133(k) associated with a corresponding data center. A data center edge node comprises a processor 910, memory 920, network interface unit 930 and switch hardware 940. The functions of the components of the data center edge node may be similar to those for an aggregation node, except that the memory 920 stores Data Center Level Capabilities Advertisement Process Logic 1000 and Data Center Level Capabilities Directory data 1005. The Data Center Level Capabilities Directory data 1005 comprises data center level capabilities summary data that summarized the capabilities for all PODs for a data center without exposing individual compute, storage and service node devices in each POD, as explained above. The processor 910 generates the Data Center Level Capabilities Directory data 1005 when executing the Data Center Level Capabilities Advertisement Process Logic 1000. The operations of the Data Center Level Capabilities Advertisement Process Logic 1000 are described hereinafter in connection with FIG. 12.

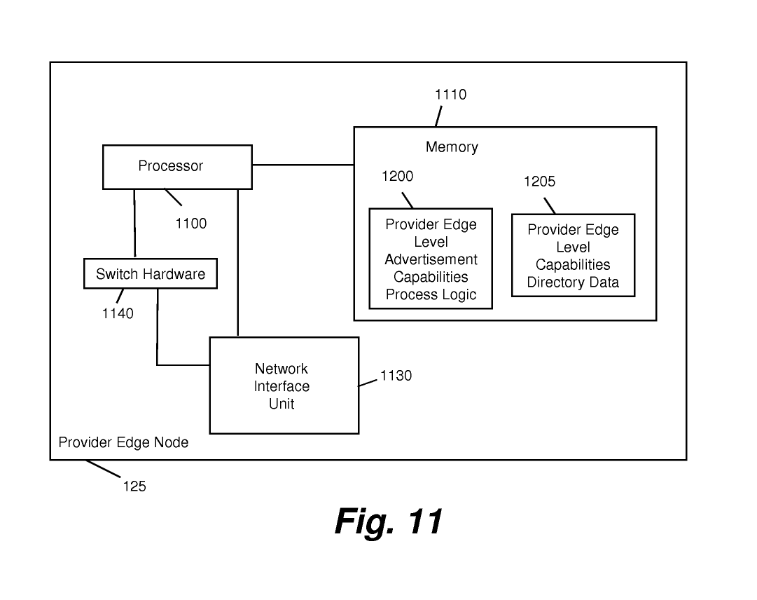

FIG. 11 illustrates an example of a block diagram of a provider edge node, e.g., edge node 125, that is configured to participate in the hierarchical capabilities advertisement techniques described herein. The provider edge node 125 comprises a processor 1100, memory 1110, network interface unit 1130 and switch hardware 1140. The memory 1110 stores executable instructions for Provider Edge Level Advertisement Capabilities Process Logic 1200 and also stores Provider Edge Level Capabilities Directory Data 1205. Operation of the Provider Edge Level Advertisement Capabilities Process Logic 1200 is described hereinafter in connection with FIG. 13. As explained above, the Provider Edge Level Capabilities Directory data comprises capabilities summary data that summarizes the capabilities of compute, storage and network devices for each data center as a whole without exposing individual compute, storage and service node devices in each data center.

Operation of the Data Center Level Capabilities Advertisement Process Logic 1000 of a data center edge node is now described in connection with the flow chart shown in FIG. 12. At 1010, a data center edge node of a data center receives messages advertising the pod level capabilities summary data from the aggregation node of each pod in that data center. As explained above, the POD level capabilities summary data describes the capabilities associated with the compute, storage and service node devices in the corresponding POD. Examples of the format of such messages are described above in connection with FIG. 5. At 1020, data center level capabilities summary data is generated that summarizes the capabilities for all pods for the data center without exposing individual compute, storage and service node devices in each pod. The data center level summary data may be generated according to any of the summarization techniques described above in connection with FIGS. 4-7. At 1030, the data center edge node generates and sends a message advertising the data center level capabilities summary data to a provider edge node.

As explained above, in one example, the techniques described herein are used for two hierarchical levels: data center level and provider edge level. In this case, each data center is viewed as effectively one large pod. Thus, in this example scenario, data center level capabilities data is generated the summarizes the capabilities of the data center, messages advertising the data center level capabilities summary data is sent from each data center to a designated device at the provider edge network level.

Operation of the Provider Edge Level Advertisement Capabilities Process Logic 1200 is now described with reference to FIG. 13. At 1210, the provider edge node receives from data center edge nodes messages advertising the data center level capabilities summary data from the respective data centers. At 1220, the provider edge node generates provider edge network level capabilities summary data that summarizes capabilities of compute, storage and network devices within each data center as a whole and without exposing individual compute, storage and service node devices in each data center at the provider edge network level. The provider edge summary data may be generated according to any of the summarization techniques described above in connection with FIGS. 4-7.

Techniques are described herein for hierarchical advertisement of resources and capabilities within and between data centers. Above the lowest level of the hierarchy (e.g., the POD level), aggregated/summarized resources and capabilities are associated with entire child (POD level) domains, without exposing individual elements within the child domain to higher level domains (e.g., data center level and provider edge network level) in the hierarchy.

These techniques utilizes a “push” or “publish/subscribe” approach to discovery of resource and capabilities that scales much better than other network management approaches, e.g., those that involve polling. This allows for use across cloud computing networks comprising numerous data centers with hundreds of thousands of servers per data center. Although one implementation described herein involves three levels of hierarchy as described above (POD, Data Center, and Provider Edge/NGN), this mechanism allows for an arbitrary number of hierarchical levels, allowing customers to control the tradeoff between accuracy and scalability.

In addition, these techniques allow for tracking of dynamic capacities that fluctuate as cloud service requests come and go and also fluctuate due to varying traffic loads. Cloud elements can control their own resource allocation and utilization, as opposed to centralized resource control where all accounting and decision making is centralized at network management stations. Cloud elements do not need to be dedicated exclusively one particular network management station, increasing flexibility and avoiding synchronization problems between cloud elements and network management stations.

In summary, in a computing system comprising a plurality of data centers, each data center comprising a plurality of compute, storage and service node devices, a method is provided comprising: generating data center level capabilities summary data that summarizes the capabilities of the data center; sending messages advertising the data center level capabilities summary data from a designated device of each data center to a designated device at a provider edge network level of the computing system; and at the designated device at the provider edge network level, generating provider edge network level capabilities summary data that summarizes capabilities of compute, storage and network devices for each data center as a whole and without exposing individual compute, storage and service node devices in each data center.

Similarly, provided herein in another form is one or more computer readable storage media encoded with software comprising computer executable instructions and when the software is executed operable to: generate data center level capabilities summary data that summarizes the capabilities of a data center in a computing system comprising a plurality of data centers; and send messages advertising the data center level capabilities summary data to a designated device at a provider edge network level of the computing system.

Further still, in other form, an apparatus is provided comprising a network interface unit configured to communicate over a network; and a processor. The processor is configured to configured to: generate data center level capabilities summary data that summarizes the capabilities of a data center in a computing system comprising a plurality of data centers, each data center comprising compute, storage and service node devices; and send messages advertising the data center level capabilities summary data to a designated device at a provider edge network level of the computing system.

Moreover, a system is provided comprising a plurality of data centers, each data center comprising a plurality of compute, storage and service node devices; and a designated device of each data center configured to: generate data center level capabilities summary data that summarizes the capabilities of the data center; send messages advertising the data center level capabilities summary data to a designated device at a provider edge network level that is in communication with the designated devices for the respective data centers; and wherein the designated device at the provider edge network level is configured to: generate provider edge network level capabilities summary data that summarizes capabilities of compute, storage and network devices for each data center as a whole and without exposing individual compute, storage and service node devices in each data center.

Although the apparatus, system and method are illustrated and described herein as embodied in one or more specific examples, it is nevertheless not intended to be limited to the details shown, since various modifications and structural changes may be made therein without departing from the scope of the apparatus, system, and method and within the scope and range of equivalents of the claims. Accordingly, it is appropriate that the appended claims be construed broadly and in a manner consistent with the scope of the apparatus, system, and method, as set forth in the following.

What is claimed is:

1. A method comprising:
in a computing system comprising a plurality of data centers, each data center comprising a plurality of compute, storage and service node devices, generating data center level capabilities summary data that summarizes the capabilities of the data center;
sending messages advertising the data center level capabilities summary data from a designated device of each data center to a designated device at a provider edge network level of the computing system; and
at the designated device at the provider edge network level, generating provider edge network level capabilities summary data that summarizes capabilities of compute, storage and network devices for each data center as a whole and without exposing individual compute, storage and service node devices in each data center.

2. The method of claim 1, wherein generating the provider edge network level capabilities summary data comprises generating data that summarizes the capabilities of a given data center and that does not specifically refer to or identify any particular compute, storage or service node device in any of the data centers.

3. The method of claim 1, wherein each data center comprises a plurality of pods each of which comprises compute, storage and service node devices, and further comprising receiving at a designated device in each pod messages advertising capabilities from compute, storage and service node devices in the pod; at the designated device in each pod generating pod level capabilities summary data describing the capabilities associated with the compute, storage and service node devices in the corresponding pod; and sending from each designated device in each pod messages advertising the pod level capabilities summary data to the designated device for the corresponding data center.

4. The method of claim 3, and further comprising receiving at the designated device of each data center the messages advertising pod level capabilities summary data from the designated device of each pod in the corresponding data center; and wherein generating the data center level capabilities summary data comprises generating data that summarizes the capabilities for pods without specifically referring to or identifying a particular compute, storage or service node device in any of the pods.

5. The method of claim 4, wherein each pod comprises a plurality of clusters of compute devices, and further comprising receiving at each designated device in each pod messages advertising capabilities of each cluster of compute devices in the corresponding pod, and wherein the pod level capabilities summary data includes data representing capabilities of each cluster of compute devices in the corresponding pod.

6. The method of claim 1, wherein sending the messages advertising the data center level capabilities summary data comprises sending the messages using a presence protocol.

7. The method of claim 1, wherein generating data center level capabilities summary data comprises, with respect to capabilities for compute, storage and service node devices, aggregating capabilities data including compute capabilities, bandwidth, and storage capacity, using one or more operations including adding, concatenating, multiplying, dividing, averaging, intersection, computing a maximum, computing a minimum, computing a lesser of, and computing a greater of.

8. The method of claim 1, wherein generating at the designated device for each data center is performed at an edge switch device in each data center.

9. The method of claim 1, wherein generating data center level capabilities summary data comprises generating data summarizing compute capacities of compute devices, storage capacities of storage devices, firewall and load balancing capabilities of service node devices, and bandwidth capabilities of access switches.

10. One or more computer readable storage media encoded with software comprising computer executable instructions and when the software is executed operable to:
generate data center level capabilities summary data that summarizes the capabilities of a data center in a computing system comprising a plurality of data centers; and
send messages advertising the data center level capabilities summary data to a designated device at a provider edge network level of the computing system.

11. The computer readable storage media of claim 10, and further comprising instructions that are operable to receive messages advertising pod level capabilities summary data from a designated device of each of a plurality of pods within a data center, each pod comprising a plurality of compute, storage service node devices; and wherein the instructions that are operable to generate the data center level capabilities summary data comprises instructions that are operable to generate data that summarizes the capabilities for pods without specifically referring to or identifying a particular compute, storage or service node device in any of the pods.

12. The computer readable storage media of claim 10, wherein the instructions that are operable to send the messages advertising the data center level capabilities summary data comprise instructions that are operable to send the messages using a presence protocol.

13. The computer readable storage media of claim 10, wherein the instructions that are operable to generate data center level capabilities summary data comprises instructions that are operable to, with respect to capabilities for compute, storage and service node devices, aggregate capabilities data including compute capabilities, bandwidth, and storage capacity, using one or more operations including adding, concatenating, multiplying, dividing, averaging, intersection, computing a maximum, computing a minimum, computing a lesser of, and computing a greater of.

14. An apparatus comprising:
a network interface unit configured to communicate over a network;
a processor configured to:
generate data center level capabilities summary data that summarizes the capabilities of a data center in a computing system comprising a plurality of data centers, each data center comprising compute, storage and service node devices; and
send messages advertising the data center level capabilities summary data to a designated device at a provider edge network level of the computing system.

15. The apparatus of claim 14, wherein the processor is configure to receive messages advertising pod level capabilities summary data from a designated device of each of a plurality of pods that comprises compute, storage service node devices; and wherein the instructions that are operable to generate the data center level capabilities summary data comprises instructions that are operable to generate data that summarizes the capabilities for pods without specifically referring to or identifying a particular compute, storage or service node device in any of the pods.

16. The apparatus of claim 14, wherein the processor is configured to generate data center level capabilities summary data, with respect to capabilities for compute, storage and service node devices, by aggregating data including compute capabilities, bandwidth, and storage capacity, using one or more operations including adding, concatenating, multiplying, dividing, averaging, intersection, computing a maximum, computing a minimum, computing a lesser of, and computing a greater of.

17. A system comprising:
a plurality of data centers, each data center comprising a plurality of compute, storage and service node devices; and
a designated device of each data center configured to:
generate data center level capabilities summary data that summarizes the capabilities of the data center;
send messages advertising the data center level capabilities summary data to a designated device at a provider edge network level that is in communication with the designated devices for the respective data centers;
the designated device at the provider edge network level configured to:
generate provider edge network level capabilities summary data that summarizes capabilities of compute, storage and network devices for each data center as a whole and without exposing individual compute, storage and service node devices in each data center.

18. The system of claim 17, wherein the designated device at the provider edge network level is configured to generate the provider edge network level capabilities summary data comprising data that summarizes the capabilities of a given data center and that does not specifically refer to or identify any particular compute, storage or service node device in any of the data centers.

19. The system of claim 17, wherein each data center comprises a plurality of pods each of which comprises compute, storage and service node devices, and wherein a designated device of each pod is configured to:
receive messages advertising capabilities from compute, storage and service node devices in the pod;
generate pod level capabilities summary data describing the capabilities associated with the compute, storage and service node devices in the corresponding pod; and
send messages advertising the pod level capabilities summary data to the designated device for the corresponding data center.

20. The system of claim 19, wherein the designated device of each data center is configured to:
receive the messages advertising pod level capabilities summary data from the designated device of each pod in the corresponding data center; and
generate the data center level capabilities summary data that summarizes the capabilities for pods without specifically referring to or identifying a particular compute, storage or service node device in any of the pods.

21. The system of claim 20, wherein each pod comprises a plurality of clusters of compute devices, and wherein the designated device in each pod is configured to receive messages advertising capabilities of each cluster of compute devices in the corresponding pod, and generate the pod level capabilities summary data including data representing capabilities of each cluster of compute devices in the corresponding pod.
